(19) United States
(12) Patent Application Publication
(10) Pub. No.: US 2005/0188334 A1
(43) Pub. Date: Aug. 25, 2005

(54) Circuit design interface

(76) Inventors: Gaurav Rameshbhai Shah, Caldwell, ID (US); Denise Susan Man, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/785,748

(22) Filed: Feb. 24, 2004

(51) Int. Cl. G06F 17/50

(52) U.S. Cl. 716/1

(57) ABSTRACT

One example embodiment of an interface arrangement for retrieving circuit design data comprises a first application program callable function configured to, in response to an application programming interface (API) call to the first function that specifies a block, read design data related to the block in a first format and store the design data in a second format different from the first. The interface arrangement further comprises a second application program callable function configured to, in response to an API call to the second function requesting block characteristics from the design data stored in the second format, access the stored design data in the second format and return information regarding characteristics of the specified block.

### BACKGROUND

Circuit designs are generally created and implemented using tools that generate information that is stored in one or more databases. This information may be accessed for analysis and testing of the design. Access to the information stored in the database typically requires database-specific programming and compilation.

A variety of tools are sometimes used to create different parts of the design, resulting in databases that vary from tool to tool. Different tools have different strengths for addressing application-specific requirements or different underlying circuit technologies. For analysis purposes, still other tools may be made to provide a global view of the design as stored in the different databases.

A tool developed for accessing the design information in one or more databases must be programmed for each of those databases. Thus, if a change is made to the schema of any one of the underlying databases, the analysis tool must also be updated. Maintaining compatibility between an analysis tool and the various underlying databases may require a substantial commitment of resources. If the entity doing the analysis of the design is also the entity responsible for maintaining the analysis tool, devoting resources for tool maintenance may be undesirable.

### SUMMARY

According to an example embodiment of the present invention, an interface arrangement and approach is implemented for retrieving circuit design data. A first application program callable function is configured to, in response to an application programming interface (API) call to the first function that specifies a block, read design data related to the block in a first format and store the design data in a second format different from the first. A second application program callable function is configured to, in response to an API call to the second function requesting block characteristics from the design data stored in the second format, access the stored design data in the second format and return information regarding characteristics of the specified block.

It will be appreciated that various other embodiments are set forth in the Detailed Description and Claims that follow.

### BRIEF DESCRIPTION OF THE DRAWINGS

FIG. 1 shows an application programming interface (API) for interfacing between and application program and two or more-types of data storage arrangements/approaches, according to an example embodiment of the present invention;

FIG. 2 shows an interface system for interfacing between an application program and two or more-types of data sources, according to another example embodiment of the present invention;

FIG. 3 shows an example arrangement and approach for retrieving design data for a circuit recognition type approach, according to another example embodiment of the present invention;

FIG. 4 is a flow diagram for an approach for generating formatted design block data using one of two or more types of data sources, according to another example embodiment of the present invention; and

FIG. 5 is a flow diagram of a method for providing access to information that describes a circuit design, according to another example embodiment of the present invention.

### DETAILED DESCRIPTION

According to an example embodiment of the invention, an application programming interface (API) supports retrieval of block information for a design across multiple types of underlying databases or database schemas. The retrieved data is formatted and stored in a memory by the interface to facilitate further access via the API. In response to subsequent API calls relating to the formatted data, the interface reads the formatted data from the memory and returns the data to the calling program. The interface facilitates retrieval of design block information by a calling program without requiring the calling program to be specifically programmed for any particular underlying database. In addition, the interface formats the retrieved design block data with an interface that requires simple coding and maintenance while facilitating flexibility for use with different types of data sources.

The interface discussed above facilitates interaction with different data and/or database types while providing a consistent interface with a user's program. In one example the API input parameters include information regarding a particular design block that the user wants to retrieve. The interface receives the input parameters including the block name and path, finds the information related to the design block and retrieves the information. For example, if the design block is stored in a structured query language (SQL) database, the interface uses an SQL query to retrieve the information. Similarly if the design block is defined in extensible markup language (XML), the interface retrieves the information from an XML file using functions that recognize XML. In this regard, the interface can be programmed to retrieve information for either an SQL or XML database in response to consistent input parameters (i.e., the user does not have to tailor the input parameters to the database type).

The retrieved design block information is then formatted for subsequent API calls and stored in a memory that is accessible to the interface. Upon a subsequent API call by the user's program for information regarding the block, such as the name of the block or of elements within the block, the interface returns the information to the user from the formatted data stored in the interface memory. With this approach, the underlying database schema for design information is effectively hidden from a user's program. In addition, programming changes made in connection with a change to a database schema can be carried out at the interface, rather than in a user's program, shielding users from changes to the underlying databases and thereby presenting a generally unchanging interface to the users' programs.

The interface may be used to support a variety of user programs. For example, in one application, the interface may be used to support a circuit simulation tool. Circuit simulation tools that can be implemented with the interface include those for testing one or more of the following characteristics of design represented by the block: timing, capacitance and electrical rules (e.g., with electrical rule checking (ERC) software). This tool maybe be implemented, for example, using one or more of the approaches herein for retrieving design block data. The retrieved design block data may be analyzed for identifying potential problem areas for a particular design including, for example, areas susceptible to electromigration and self-heating.

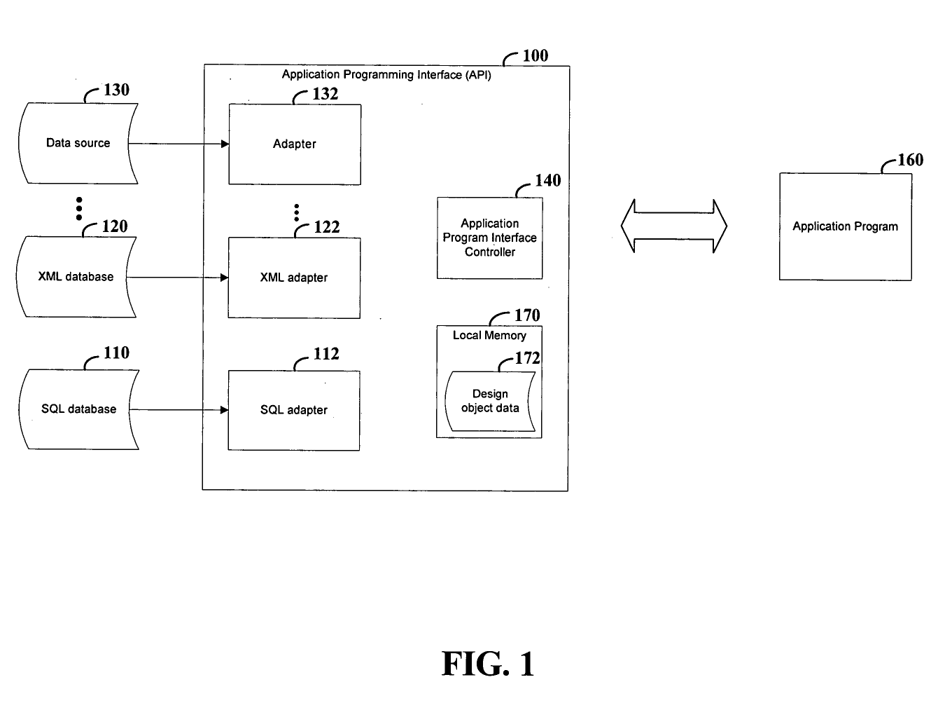

FIG. 1 shows an API that provides an interface for a user's program (application program) to circuit design information stored in two or more different data storage approaches or different data storage arrangements. The interface 100 may be invoked to retrieve data from a multitude of data sources such as SQL database 110, XML file 120 and other types of data storage approaches and arrangements as represented by block 130. The data sources may include, for example, one or more database locations local and/or remote to the interface 100 (e.g., locations that require either local or wide area network communications for access). The interface 100 further includes an adapter for each type of data source from which the interface is to retrieve data. Specifically, adapters 112, 122 and 132 respectively retrieve and format design data from data sources 110, 120 and 130. The address (e.g., IP address) of the database from which a particular adapter is to retrieve data can be provided with the first API call and/or is optionally stored in a configuration file accessible by the adapter. A local memory 170 stores formatted design object data 172 for subsequent use in responding to circuit recognition design-data retrieval-type calls including, for example, circuit recognition/verification type calls to return information regarding design information such as field effect transistor (FET) and/or netlist (NET) information. An API controller 140 facilitates the retrieval of design blocks from the data sources 110, 120 and 130, as well as the subsequent access to the local memory 170 for circuit recognition-type calls.

The API 100 interfaces with a user's application program 160 and data sources 110, 120 and 130 for providing circuit recognition functions in a variety of manners, depending upon the particular application, data source availability and user preference. The application program 160 makes an API call to the interface 100 by sending sufficient information (i.e., block name and path) needed by the interface 100 to retrieve the block. This information is used by the interface 100 to determine a particular data source from which to retrieved design data.

When sufficient information for retrieving a design block is received, the API controller 140 invokes the appropriate adapter for the particular data source from which the design block is to be retrieved. The invoked adapter reads design block data from the data source using data source schema-specific queries and via a protocol specific to the data source. The invoked adapter returns and formats the design block data, which is stored in the local memory 170 as an object for use with subsequent calls from the application program 160. The design data is formatted such that the format of the data stored in local memory 170 is substantially independent from the type of data source from which the data is retrieved. In this regard, subsequent API calls to the local memory 170 are made using similar calls for design data retrieved from different types of data sources. With this approach, similar API calls can be made in a manner that is generally independent from the type of underlying data source from which design block data is retrieved.

In one implementation, the interface 100 retrieves data from a specific data source identified in an API call received from the application program 160. A user desiring that a specific data source be used for retrieving a design block thus includes information in the API call that identifies that data source along with the design block's name and path. For purposes of this discussion, the “user” is contemplated as a particular human user supplying inputs to the application program 160 and/or the application program 160 itself selecting a particular data source as a function of programming. The data source identifying information may include, for example, a particular Internet Protocol (IP) address or other identification characteristic one of the data sources 110, 120 or 130.

In another implementation, the interface 100 chooses a location from which to retrieve the design block data as a function of predefined conditions programmed for the API controller 140. In this regard, a user can supply simply a design block's name and path, without necessarily specifying a particular type of data source or data source location. The API 100 is configured to use the design block's name and path to select a data source (and corresponding adapter) from which to retrieve the design block. This approach is useful, for example, to provide efficient data source use and data retrieval, as well as a user-friendly interface that does not require the user to know the location of a data source from which to retrieve data.

A multitude of conditions can be used in selecting a particular data source from which to retrieve data. For example, multiple parties often share databases. In this regard, the availability of a particular database can be limited, depending upon the number of users accessing the database. In addition, certain databases facilitate data retrieval at different speeds, relative to other databases. For instance, design block data stored in a database employing SQL may be accessible at a different speed than the same design block data stored in a database employing XML, depending upon characteristics of the database and/or the design block data. Speed characteristics that are related to the processing of design block data at the interface, such as the amount of time it takes an adapter to populate the local memory 172, can also be different for different types of data. Furthermore, it may be preferred that the design block data be retrieved from a particular type of database, depending upon user preferences and/or the ability of the interface 100 to process a particular type of data. In this regard, the interface 100 can selectively retrieve design block data from a particular data source as a function of one or more of these and/or other characteristics related to the data retrieval. Weight can be given to the importance of the speed and/or type of database in which the design block data to be retrieved is stored. This weight can be used in making a decision regarding the database location from which the design block data is retrieved. Depending upon the type of database used, the interface 100 invokes an adapter and/or other processing characteristics that correspond to the type of database from which the design block data is retrieved.

In another implementation, the interface 100 uses a predefined sequence to determine a location from which to retrieve the design block data from a group of potential data locations including multiple databases. For instance, the interface 100 can be programmed with a list of the multiple databases and a particular sequence to be used in selecting a database from which to retrieve design block data. When a call for a particular block is received from the application program 160, the interface 100 uses the sequence to determine which database to retrieve the design block data from. Upon a subsequent call for another block from the application program 160, the interface retrieves the design block data from a database that is next in the sequence. This sequential data retrieval may, for example, involve the use of a pointer that is incremented through the sequence as design block data is retrieved.

In still another implementation, design block information is stored in two or more data source locations and the interface 100 is configured to randomly select a location from which to retrieve the design block data. For instance, when a call from the application program 160 for a particular design block is received at the interface 100, the interface identifies database locations from which to retrieve the design block data (i.e., using database locations known to carry the requested design block). The interface 100 then uses a random function to select one of the database locations from which to retrieve the design block data. With this approach, data source use is generally leveled across available data sources.

Other implementations involving selective access to data source locations include selecting data source locations as a function of data retrieval efficiency and/or user access priority. For example, where a particular design block is available from two different data sources and one of the data sources facilitates a more efficient (e.g., faster) data retrieval, the interface selects the more efficient data source. As another example, access privilege to a particular data source is assigned to users making API calls, with each API call identifying this access privilege. The interface uses the access privilege from the API call to select a data source from which to retrieve the design block data identified in the API call.

The local memory 170 can be implemented using one or more of a variety of memory arrangements and approaches. In one implementation, the local memory 170 includes an in-memory architecture having processor-in-memory type circuitry. The in-memory architecture includes logic circuits (e.g., CMOS logic circuits) and memory cells on a common semiconductor die. With this approach, a readily implemented local memory provides a particular in-memory architecture that is useful for user-specific storage of block data, with additional in-memory architectures being implemented for additional users. Other memory arrangements and approaches may be used to satisfy different implementation requirements.

Various other embodiments employ combinations of two or more of the above implementations involving the selection of a particular data source from which to retrieve design block data. For example, a random element may be used in connection with predefined conditions in selecting one of a multitude of database locations from which to retrieve design block data. As another example, a user can specify a particular type of data source from which to retrieve data without necessarily specifying the exact data source. The API controller 140 then selects a data source of the specified type from among two or more data sources (if more than one data source of the specified type is available).

In another implementation, the interface 100 is programmed to use two different data sources to evaluate API-related functions. In response to a particular API call, the interface 100 retrieves design blocks from two data sources and stores each in the local memory 170. When the application program calls the API for the design block, the interface 100 returns both sets of design block information to the application program 160. These sets of information may be cross-checked by the application program to determine whether they are consistent.

In another implementation, the interface 100 is programmed for editing design block information retrieved by the interface. The application program 160 provides sufficient information to the interface 100 for retrieving a particular design block as described, for example, in the various implementations above. The interface 100 retrieves the design block identified by the application program 160 from one of the data sources 110, 120 or 130 (using a corresponding adapter) and stores the retrieved design block in the local memory 170. The application program 160 reads characteristics of the retrieved design block and returns information for an edited version thereof to the interface 100. The editing may be implemented, for example, using a text editor such as a unified editor (UE) that unifies multiple functionality, such as word processing and XML text editing, at the application program 160 and/or a user input arrangement used therewith. The edited design block can then be implemented, for example, with circuit recognition-type approaches in a manner similar to that described above (e.g., stored in the local memory 170 and accessed by the application program 160 via the interface 100).

In still another implementation, the interface 100 is further adapted to write a design block edited as described in the paragraph above back to one or more data sources. The edited design block is either received from the application program 160 or edited at the interface 100 at the direction of the application program. The edited design block is then written back to one or more data sources, such as the data source from which it was read, by the interface 100. An adapter corresponding to the data source to which the edited data is written is used to format the data for storage in the data source. The adapter may, for example, be implemented with an adapter also used to format data read from a data source and stored in the memory 170 (e.g., adapter 112, 122 and/or 132).

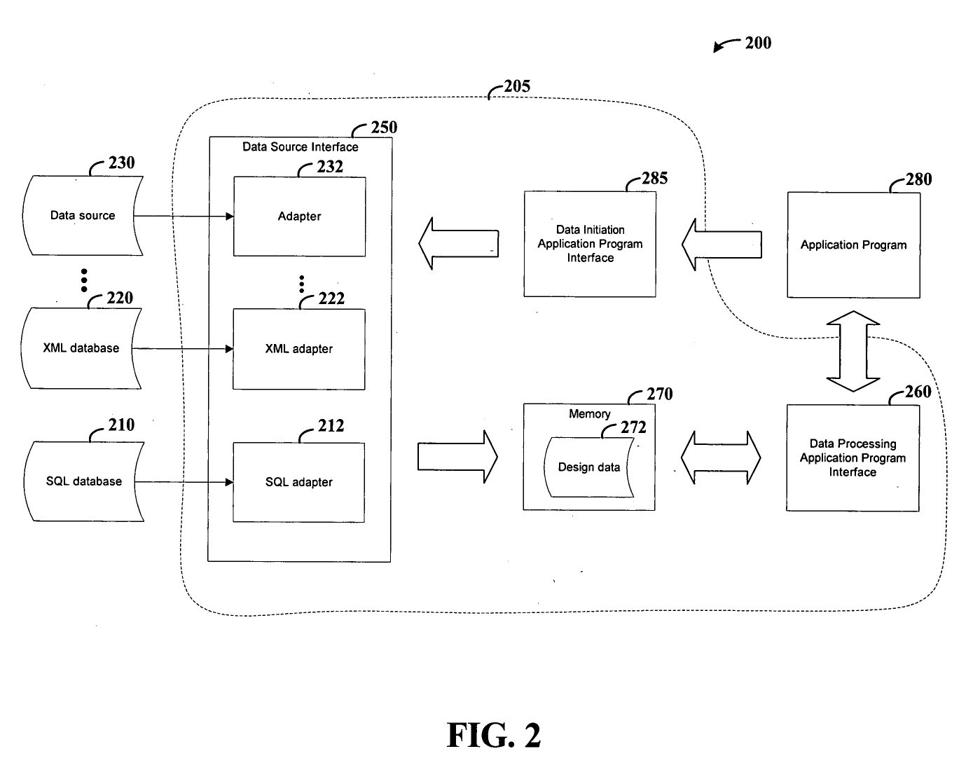

FIG. 2 shows an interface system 200 for implementing a user's program (application program) to circuit design information, according to another example embodiment of the present invention. The interface system 200 may, for example, be implemented in a manner similar to the interface 100 of FIG. 1, with various functions thereof being performed by certain components as grouped by dashed line 205 and as described below. The interface system 200 includes a data initiation API 285, a data source interface 250, a data processing API 260 and a memory 270. In one implementation, the data initiation API 285 and the data processing API 260 are implemented as a single API with separate calls going respectively to the interface 100 and the memory 270 for initiation and processing calls. The data initiation API 285 interfaces with an application program 280 for receiving and processing design block location information (i.e., block name and path and, in some instances, data source for the design block). The data initiation API 285 sends the design block information to the data source interface 250, which retrieves the design block specified by the application program. The data source interface 250 is adapted to retrieve data from a variety of sources such as an SQL database 210, XML database 220 and others represented by data source 230. The data is retrieved using data source-specific adapters such as an SQL adapter 212, XML adapter 222 and/or other adapters represented by adapter 232, which format the data for use in subsequent API calls from the application program 280.

Once the data source interface 250 has retrieved and formatted the design block, formatted design data 272 for the design block is stored in the memory 270. The data processing API 260 is adapted to receive and process subsequent API calls from the application program 280 for retrieving specific information about the design block data 272. The API calls made via the data processing API 260 may include a multitude of calls typically made for circuit recognition and other design-related calls. These API calls can be substantially similar (e.g., identical) for design block data retrieved from different data sources due to the formatting of the data by one of the adapters. For example, calls for the number, name and/or function of one or more FETs in the design block and NET information for describing the relationship of the FETs are made generally independent of the underlying data source type.

The design data 272 stored in the local memory 270 can be retained for future use or deleted. The retention of the design data 272 may, for example, depend upon the available memory at the interface. For instance, with limited memory, the interface might be controlled for maintaining a fixed amount of design data. When the fixed amount is reached and/or exceeded, certain design data is deleted, such as the least-used or least-recently-used data.

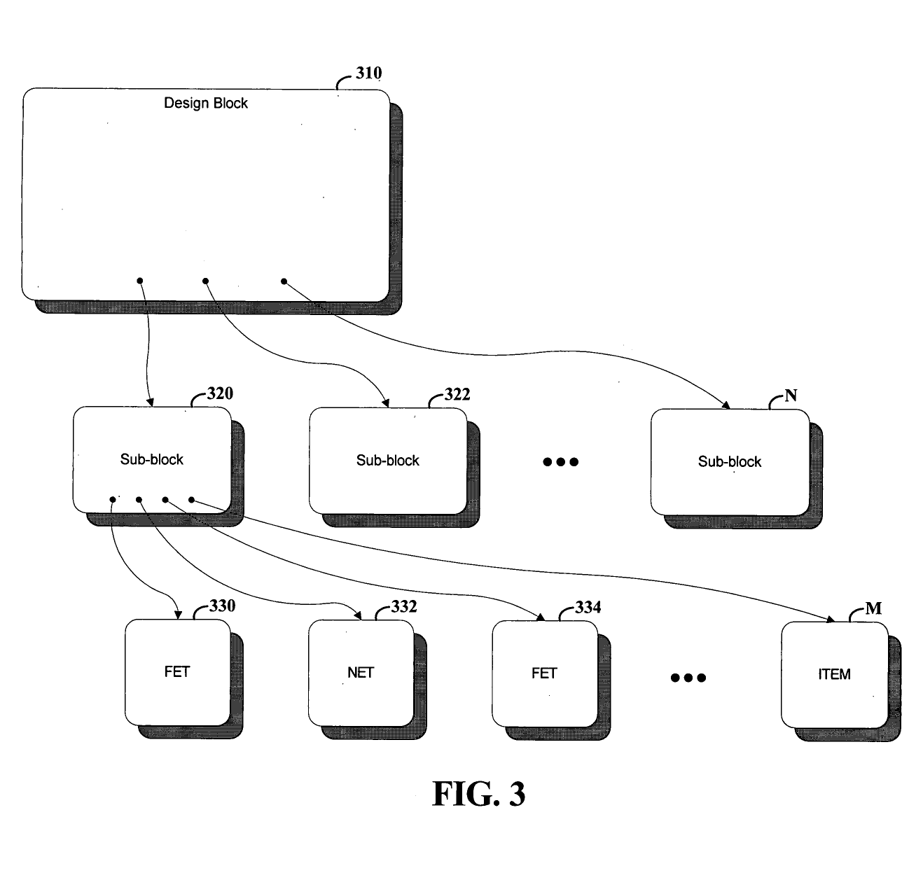

FIG. 3 shows an example arrangement and approach 300 for storing and retrieving formatted design data for a circuit recognition type approach, according to another example embodiment of the present invention. When an adapter retrieves design block data from a data source, the data is formatted such that subsequent API calls for the data can be generally consistent for design block data retrieved from different types of data sources. For instance, the adapter can retrieve data in a conventional manner for the underlying data source, with the resulting block data being stored in a format (e.g., object data) that is consistent among different data source types. A design block 310 is formatted and stored in a local memory at an interface arrangement, such as local memory 170 shown in FIG. 1. The design block 310 may include one or more sub-blocks including sub-blocks 320 and 322-N (with N indicating one or more additional sub-blocks). Each sub-block may include one or more design elements such as FETs, NETs and others. Referring to sub-block 320 as an example, FET 330, NET 332 and design element M are all part of the sub-block (with M indicating one or more additional design elements such as FETs and NETs (and connections therebetween).

Access to the information of design block 300 may be effected as follows. When a user wishes to learn of the name and classification of the FETs in sub-blocks of the block 310, a first call is made to return the name of the sub-blocks. A call is then made identifying a particular one of the sub-blocks and requesting information regarding the names of FETs in the sub-block. Using sub-block 320 as an example, the names of the FETs 330, 334 (and more, if applicable) are returned. Using FET 330 as an example, a call is made via sub-block 320 requesting the property of FET 330. In some implementations, a call can be made directly to the FET 330 when the name of the FET is known. Using this type of approach, a variety of information (e.g., object data) about the design block 310 can be retrieved, such as block name, parent name, property data, FET name, FET property, NET name, NET property and NET type value.

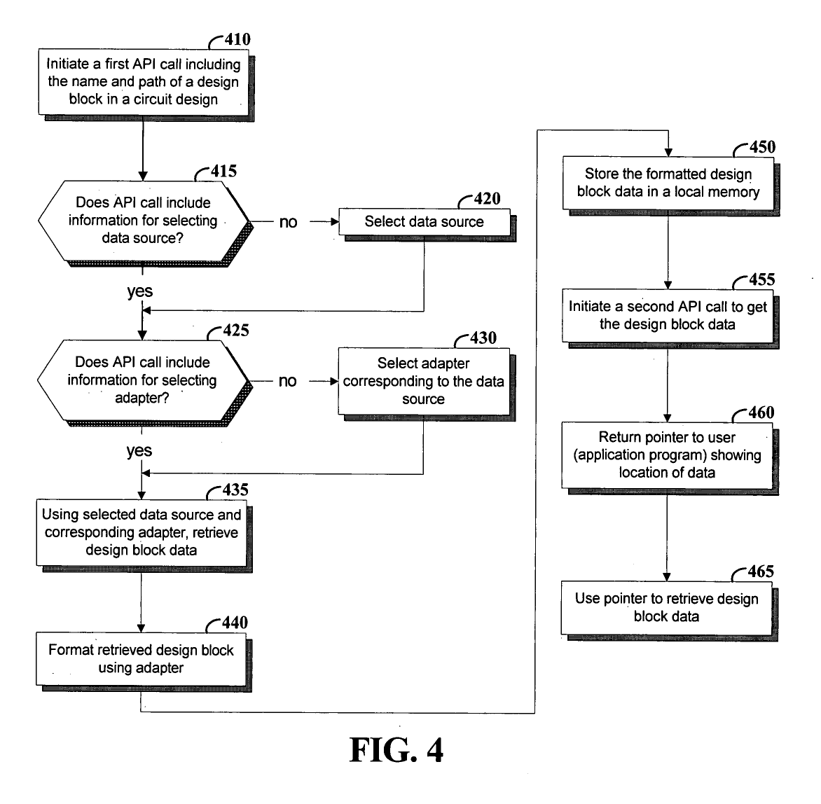

FIG. 4 is a flow diagram for an approach to generating formatted design block data using one of two or more types of data sources, according to another example embodiment of the present invention. This approach may, for example, be implemented using one or more of the arrangements shown in FIGS. 1 and 2 and discussed above. At block 410, a first API call (using, e.g., C++ language) is made including the name and path of a particular design block to return. In some instances, the name of a particular data source and/or adapter to use in retrieving the design block is also included in the first API call. If the API call does not include information for selecting a data source at block 415, a data source is selected at block 420 using one or more of a variety of approaches. For instance, program for selecting a data source can be implemented to select a data source randomly and/or as a function of variables in a manner similar to the above-discussed approaches. If the API call does not include information for selecting a particular adapter at block 425, an adapter corresponding to the data source is selected at block 430. In one implementation wherein the API call includes information for selecting a particular type of adapter but does not identify a particular data source, the data source is selected at block 420 as a function of the adapter. Specifically, where the selected adapter is for a particular data source type, a data source that employs the same language as the language used by the adapter is selected.

Once a data source and adapter have been selected, either by the API call or at block(s) 420 and/or 430, design block data is retrieved at block 435. The retrieved design block data is formatted with the selected adapter at block 440 and the formatted design block data is stored in a local memory at block 450. The formatted design block data is now ready for access by an application program interface for retrieving design block data (e.g., circuit recognition and verification type purposes). At block 455, a second API call is made for retrieving design block data. The second API call may include a request for information about the block, sub-blocks within the block and other information including that discussed in connection with FIG. 3 above. In response to the second API call, a pointer identifying a location for the information in the call is returned at block 460 to a user (e.g., to an application program making the API call). A null pointer returned at block 460 indicates that the retrieval of the design block failed. The pointer is used at block 465 to retrieve the information for a user (e.g., application program), assuming the pointer is not null.

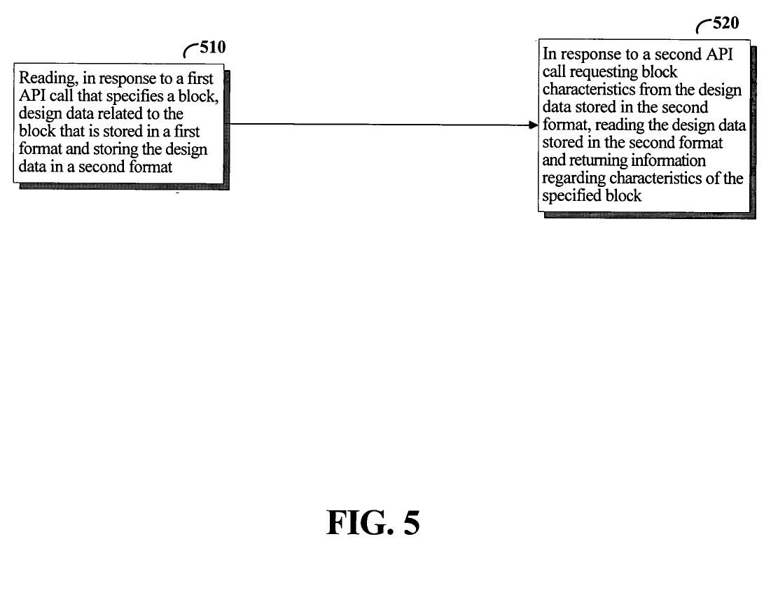

FIG. 5 is a flow diagram of a method for providing access to information that describes a-circuit design, according to another example embodiment of the present invention. At block 510 and in response to a first application programming interface (API) call that specifies a block, design data related to the block that is stored in a first format is read and stored in a second format. At block 520 and in response to a second API call requesting block characteristics from the design data stored in the second format, design data stored in the second format is read and information regarding characteristics of the specified block is returned.

Those skilled in the art will appreciate that various alternative computing arrangements would be suitable for hosting the processes of the different embodiments of the present invention. In addition, the processes may be provided via a variety of computer-readable media or delivery channels such as magnetic or optical disks or tapes, electronic storage devices, or as application services over a network.

The present invention is believed to be applicable to a variety of circuit recognition and verification-type arrangements and approaches and has been found to be particularly applicable and beneficial in presenting a consistent interface for use with different data sources. Other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

1. An interface arrangement for retrieving circuit design data, comprising:
a first application program callable function configured to, in response to an application programming interface (API).call to the first function that specifies a block, read design data related to the block in a first format and store the design data in a second format different from the first; and
a second application program callable function configured to, in response to an API call to the second function requesting block characteristics from the design data stored in the second format, access the stored design data in the second format and return information regarding characteristics of the specified block.

2. The arrangement of claim 1, wherein the first application program callable function is configured to interface with at least two different types of data sources for, reading the design data and to store design data read from at least one of the at least two different types of data sources in the second format.

3. The arrangement of claim 2, further comprising a data source selection function configured to select one of the at least two different types of data sources as a function of the API call to the first function.

4. The arrangement of claim 3, wherein the data source selection function is configured to select one of the at least two different types of data sources as a function of a data source identified in the API call.

5. The arrangement of claim 3, wherein the data source selection function is configured to select one of the at least two different types of data sources as a function of sequential data source use wherein each of the at least two different types of data sources is accessed for subsequent API calls in a sequence defined at the data source selection function.

6. The arrangement of claim 3, wherein the data source selection function is configured to randomly select one of the at least two different types of data sources having the block.

7. The arrangement of claim 3, wherein the data source selection function is configured to select one of the at least two different types of data sources as a function of the efficiency of data retrieval from each of the at least two different types of data sources that has the block.

8. The arrangement of claim 3, wherein the data source selection function is configured to select one of the at least two different types of data sources as a function of user access privilege assigned to a user initiating the API call for each particular data source.

9. The arrangement of claim 2, further comprising an adapter for each of the at least two different types of data sources, each adapter being configured to read the design data from its respective data source and translate the design data into the second format.

10. The arrangement of claim 9, wherein the first application program callable function is configured to use a particular adapter as a function of the API call.

11. The arrangement of claim 10, wherein the first application program callable function is configured to use an adapter identified by the API call.

12. The arrangement of claim 10, wherein the first application program callable function is configured to use an adapter that is associated with a particular type of data source identified in the API call.

13. The arrangement of claim 10, wherein the first application program callable function includes a data source selection function configured to select one of the at least two different types of data sources and an adapter selection function configured to automatically select an adapter associated with the selected one of the at least two different types of data sources.

14. The arrangement of claim 2, wherein the first application program callable function is configured to read and store design data from each of two different types of data sources in response to the API call, the design data from each data source being stored in the same second format, wherein the second application program callable function is configured to, in response to the API call to the second function, access the stored design data from each data source and return information regarding characteristics of the specified block as read from each respective data source.

15. The arrangement of claim 14, further comprising a comparison function configured to compare the characteristics of the specified block as read from each respective data source and to generate an output as a function of the comparison.

16. The arrangement of claim 1, further comprising a local memory coupled to each of the first and second functions and adapted for storing the design data in the second format.

17. The arrangement of claim 16, wherein the local memory includes an in-memory architecture having logic circuitry and memory circuitry on a single die.

18. The arrangement of claim 16, wherein the first application program callable function is configured to populate the local memory by formatting the design data in an object-based format that is independent from the type of underlying data source from which the design data is retrieved.

19. The arrangement of claim 16, wherein the local memory is configured for being written to by an API call for changing the stored design data.

20. The arrangement of claim 19, further comprising a write function configured to write the changed design data back to a data source from which the design data was read.

21. A method for providing access to information that describes a circuit design, comprising:
reading, in response to a first application programming interface (API) call that specifies a block, design data related to the block that is stored in a first format and storing the design data in a second format; and
in response to a second API call requesting block characteristics from the design data stored in the second format, reading the design data stored in the second format and returning information regarding characteristics of the specified block.

22. The method of claim 21, further comprising selecting, in response to the first API call, one of at least two data sources containing the specified block and where reading design data includes reading design data from the selected block.

23. The method of claim 22, further comprising selecting an adapter corresponding to the selected data source to use in reading and formatting the design data in the second format.

24. The method of claim 22 wherein selecting one of at least two data sources includes selecting a data source using a predefined selection function.

25. The method of claim 21, wherein storing the design data in a second format includes storing the design data in a second format that is independent from the type of data source from which the design data is read.

26. The method of claim 21, wherein reading design data related to the block includes reading design data from at least two different types of data sources and wherein storing the design data in a second format includes storing design data read from each of the at least two different types of data sources in the second format, the stored design data from the at least two different types of data sources being substantially identical.

27. The method of claim 26, further comprising comparing the stored design data to determine a condition of similarity therebetween.

28. The method of claim 21, further comprising modifying the stored design data.

29. The method of claim 21, further comprising modifying the read design data and writing the modified design data to a data source from which the design data was read.

30. A circuit design analysis system comprising:
at least one data source configured and arranged to store design block data;
a user interface;
an application program interface (API) coupled to the user interface and configured to respond to user inputs at the user interface requesting a particular design block by generating a first API call including sufficient information for retrieving the design block;
an interface arrangement coupled to the API and configured to retrieve the requested design block data from the one of the at least one data source and to format and store the retrieved design block data in another format that is consistent for different types of underlying data sources from which the requested design block data is retrieved;
the API further configured to, in response to additional user inputs for information from the retrieved design block data, generate another API call to request information from the formatted retrieved design block data;
the interface arrangement further configured to return the requested information from the formatted retrieved design block data in response to the other API call; and
the API further configured to provide the returned requested information to a user via the user interface.

31. The system of claim 30, wherein the interface includes at least two adapters, each adapter being configured and arranged to retrieve design block data from a different type of data source and to format the retrieved design block data from its respective type of data source in a format that is consistent among the at least two adapters.

32. An interface arrangement for retrieving circuit design data, comprising:
means, responsive to an application programming interface (API) call that specifies a block, for reading design data related to the block in a first format and storing the design block data in a second format different from the first; and
means, responsive to an API call requesting block characteristics from a design block data stored in the second format, for accessing the stored design block data in the second format and returning information regarding characteristics of the specified block.
